(19) United States
(12) Patent Application Publication
(10) Pub. No.: US 2007/0006167 A1
(43) Pub. Date: Jan. 4, 2007

(54) Optimizing binary-level instrumentation via instruction scheduling

(76) Inventors: Chi-Keung Luk, Ashland, MA (US); Ady Tal, Zichron Yaacov (IL); Robert Cohn, Salem, NH (US); Jonathan Beimel, Michmoret (IL)

Correspondence Address: TROP PRUNER & HU, PC, 1616 S. VOSS ROAD, SUITE 750, HOUSTON, TX, 77057-2631, US

(21) Appl. No.: 11/140,841

(22) Filed: May 31, 2005

(51) Int. Cl. G06F 9/44

(52) U.S. Cl. 717/130

(57) ABSTRACT

In one embodiment, the present invention includes a method for receiving a command to insert instrumentation code into a code segment, analyzing the code segment to determine an optimal location for the instrumentation code within the code segment, and inserting the instrumentation code at the optimal location to generate an instrumented code segment. The instrumented code segment may then be executed and may provide for improved performance over unoptimized instrumented code. Other embodiments are described and claimed.

### BACKGROUND

Embodiments of the present invention relate to software operation, and more particularly to optimizing instrumentation code.

As software complexity increases, instrumentation, which is a technique for inserting extra code into an application to observe its behavior, is becoming more important. Instrumentation can be performed at various stages in a software development cycle: in source code, at compile time, post link time, or at run time.

Robust and powerful software instrumentation tools are used for program analysis tasks such as profiling, performance evaluation, and bug detection. In binary instrumentation systems, a user (e.g., a tool writer) specifies where in the binary image he/she desires to insert the instrumentation. Typical instrumentation points are before/after an instruction, before/after a basic block, or before/after a function. Generally, the instrumentation code is placed at the exact place specified by the user.

Static instrumentation has certain limitations compared to dynamic instrumentation. For example, it is possible to mix code and data in an executable, and a static tool may not have enough information to distinguish the two code types. Dynamic tools, in contrast, can rely on execution to discover all of the code at run time. Other difficult problems for static systems are indirect branches, shared libraries, and dynamically-generated code.

Accordingly, for at least certain applications, dynamic instrumentation can be more effective. There are two approaches to dynamic instrumentation: probe-based and just-in-time (JIT)-based instrumentation. The probe-based approach works by dynamically replacing instructions in the original program with trampolines that branch to the instrumentation code. The drawbacks of probe-based systems are that: (i) instrumentation is not transparent because original instructions in memory are overwritten by trampolines; (ii) on architectures where instruction sizes vary (e.g., an x86-based architecture), an instruction cannot be replaced by a trampoline that occupies more bytes than the instruction itself because it will overwrite the following instruction; and (iii) trampolines are implemented by one or more levels of branches, which can incur a significant performance overhead. These drawbacks make fine-grained instrumentation challenging on probe-based systems.

In contrast, the JIT-based approach is more suitable for fine-grained instrumentation, as it works by dynamically compiling the binary and inserting instrumentation code (or calls to it) within the binary. However, depending on where the code is inserted into the binary, performance degradation may occur, as the instrumentation code can affect various resources, such as registers and the like. For example, instrumentation code typically causes one or more registers that store information to be spilled and rewritten after execution of the instrumentation code. Such spilling and rewriting causes flushing of various processor resources, and thus leads to degraded performance.

A need thus exists to optimize instrumentation code.

### BRIEF DESCRIPTION OF THE DRAWINGS

FIG. 1 is a flow diagram of a method in accordance with one embodiment of the present invention.

FIG. 2 is a block diagram of a software architecture in accordance with one embodiment of the present invention.

FIG. 3 is a flow diagram of a method in accordance with an embodiment of the present invention.

FIG. 4 is a block diagram of a system in accordance with one embodiment of the present invention.

### DETAILED DESCRIPTION

In various embodiments, efficient instrumentation may be effected by using a just-in-time (JIT) compiler to insert and optimize the instrumentation code. Code may be dynamically instrumented in various manners, including code caching and trace linking, register reallocation, inlining, liveness analysis, and instruction scheduling. While some embodiments may be performed dynamically, other embodiments may be implemented in other stages of software development.

JIT-based instrumentation in accordance with an embodiment of the present invention may defer code discovery until run time, allowing instrumentation to be robust. Embodiments can seamlessly handle mixed code and data, variable-length instructions, statically unknown indirect jump targets, dynamically loaded libraries, and dynamically generated code, among other structures.

Behavior of an original application may be preserved by providing instrumentation transparency. That is, the application observes the same addresses (both instruction and data) and same values (both register and memory) as it would in an uninstrumented execution. Transparency makes the information collected by instrumentation more relevant and correct.

In some embodiments, instrumentation is performed by a JIT compiler. The input to this compiler is not bytecodes, however, but a native executable. The compiler intercepts execution of the first instruction of the executable and generates (“compiles”) new code for the straight-line code sequence starting at this instruction. It then transfers control to the generated sequence. The generated code sequence is almost identical to the original code sequence, but the compiler ensures that it regains control when a branch exits the sequence. After regaining control, the compiler generates more code for the branch target and continues execution. Whenever the compiler fetches code, an application programming interface (API) for performing instrumentation has the opportunity to instrument the code before it is translated for execution. The translated code and its instrumentation may be saved in a code cache for future execution of the same sequence of instructions to improve performance, in some embodiments.

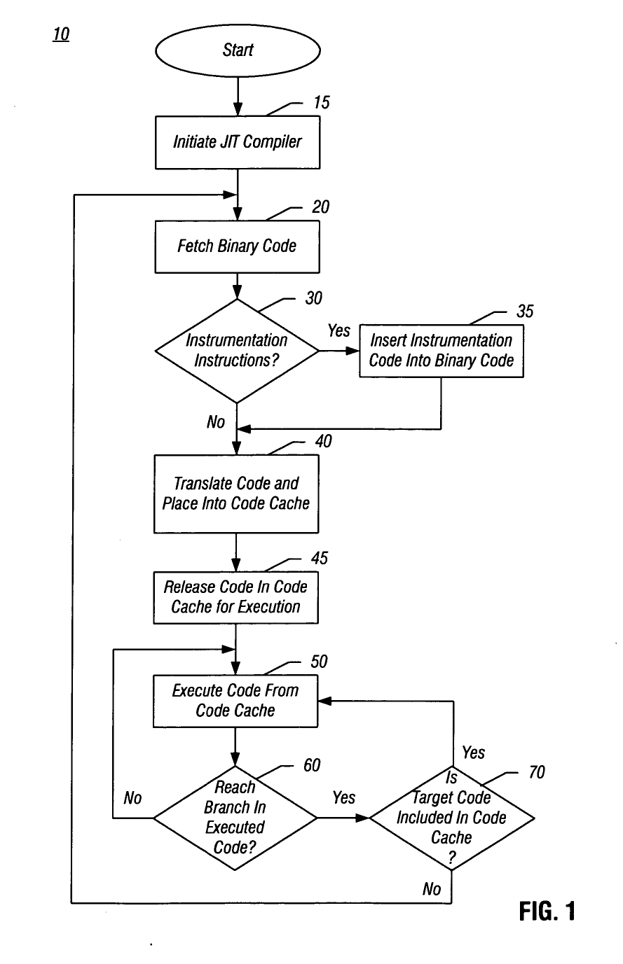

Referring now to FIG. 1, shown is a flow diagram of a method in accordance with one embodiment of the present invention. As shown in FIG. 1, method 10 may be used to perform just-in-time (JIT) compilation of code and further to dynamically instrument the code during compilation. Method 10 may begin by initiating a JIT compiler (block 15). The compiler may then fetch the binary code to be compiled (block 20). For example, in some embodiments the compiler may fetch a first portion of a native executable, for example, a first functional block. Next, the compiler may determine whether an instrumentation tool has been invoked (diamond 30). That is, the compiler may determine whether a user seeks to instrument the binary code that has been fetched. If so, the compiler inserts the instrumentation code into the binary code (block 35). As will be discussed further below, in various embodiments the instrumentation code inserted into the binary may be optimized in various manners. Next (or alternately directly from diamond 30 if no instrumentation instructions were received), the compiler translates the binary code and places the code into a code cache (block 40).

From there, the code may be released for execution (block 45). Accordingly, the code may be executed from the code cache (block 50). Execution may continue until a branch is reached in the executed code (diamond 60). Thus if no branch is reached, the code continues executing in a loop between block 50 and diamond 60. If instead, a branch is reached at diamond 60, control passes to diamond 70. There, it may be determined whether the target code is included already in the code cache (diamond 70). If so, control returns to block 50 for execution of the code from the code cache. If instead the target code is not included in the code cache, control may return to block 20, as described above.

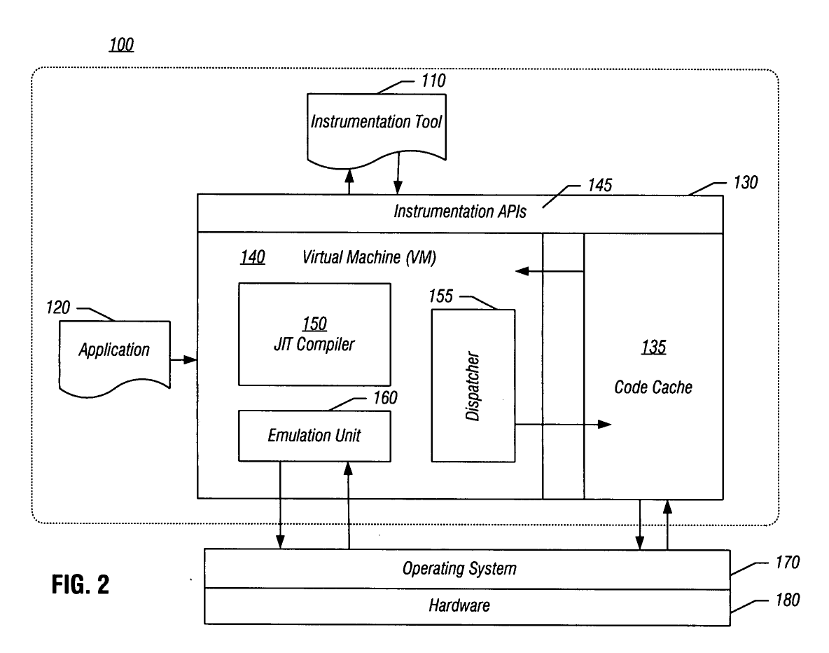

FIG. 2 is a block diagram of a software architecture in accordance with one embodiment. Software architecture 100 provides a high-level view of the interaction between instrumentation tools and other software (and hardware) of a system. A compiler 130 is used to compile an application 120. To allow a user to instrument application 120, an instrumentation tool 110 may be provided. As shown in FIG. 2, compiler 130 also interacts with an operating system (OS) 170, which in turn interacts with underlying hardware 180 of a system. As shown in FIG. 2, there are three binary programs present when an instrumented program is running namely, application 120, compiler 130, and instrumentation tool 110. Compiler 130 is the engine that performs just-in-time compilation and instruments application 120. Instrumentation tool 110 contains the instrumentation and analysis routines and is linked with a library that allows it to communicate with compiler 130.

At the highest level, compiler 130 includes a virtual machine (VM) 140, a code cache 135, and one or more instrumentation API's 145 invoked by instrumentation tool 110. VM 140 includes a JIT compiler 150, an emulation unit 160, and a dispatcher 155. After compiler 130 gains control of application 120, VM 140 coordinates its components to execute application 120. Specifically, JIT compiler 150 compiles and instruments application code, which is then launched by dispatcher 155. The compiled code is stored in code cache 135. That is, only code residing in code cache 135 is executed: the original code is not executed. Emulation unit 160 interprets instructions that cannot be executed directly, and may be used for system calls which require special handling from VM 140.

In some embodiments, an application is compiled one trace at a time. A trace is a straight-line sequence of instructions which terminates at one of the following conditions: (i) an unconditional control transfer (e.g., branch, call, or return); (ii) a predefined number of conditional control transfers; or (iii) a predefined number of instructions have been fetched in the trace. In addition to the last exit, a trace may have multiple side-exits (i.e., conditional control transfers). Each exit initially branches to a stub, which redirects control to the VM. The VM determines the target address (which is statically unknown for indirect control transfers), generates a new trace for the target if it has not been generated before, and resumes execution at the target trace.

To improve performance, in some embodiments the compiler may attempt to branch directly from a trace exit to the target trace, bypassing the stub and VM. This process is referred to herein as “trace linking”. Linking a direct control transfer is straightforward, as it has a unique target. The branch may be patched at the end of one trace to jump to the target trace. However, an indirect control transfer (e.g., a jump, call, or return) has multiple possible targets and therefore implicates a target-prediction mechanism.

Precise liveness information of registers at trace exits makes register allocation more effective, since dead registers can be reused by the compiler without introducing spills. The term “dead register” refers to a register that will have its contents modified at a next instruction (i.e., it contains invalid information). Without a complete flow graph, liveness may be incrementally computed. For example, after a trace at address A is compiled, the liveness at the beginning of the trace may be recorded in a hash table using address A as the key. If a trace exit has a statically-known target, the liveness information may be retrieved from the hash table to compute more precise liveness for the current trace. In such manner, register spills introduced by the compiler's register allocation may be reduced.

Much of the slowdown from instrumentation may be caused by executing the instrumentation code, rather than compilation time (which includes inserting the instrumentation code). Therefore, it may be beneficial to spend more compilation time in optimizing calls to analysis routines. Of course, the run time overhead of executing analysis routines highly depends on their invocation frequency and complexity. Many frequently-executed analysis routines of instrumentation code perform only simple tasks such as counting and tracing. Embodiments of the present invention may optimize those cases by inlining the analysis routines, which reduces execution overhead. Without inlining, a bridge routine is called to save all caller-saved registers, set up analysis routine arguments, and finally call the analysis routine. Each analysis routine requires two calls and two returns for each invocation. With inlining, the bridge may be eliminated and thus the two calls and returns may be avoided. Also, the caller-saved registers need not be explicitly saved. Instead, the caller-saved registers may be renamed in the inlined body of the analysis routine, allowing a register allocator to manage spilling. Furthermore, inlining enables other optimizations like constant folding of analysis routine arguments.

In various embodiments additional optimizations on instrumentation code may be effected. For example, most analysis routines modify a condition code or conditional flags register (referred to as the “eflags” register in an x86 environment). For example, if an analysis routine increments a counter, the eflags register is modified. Thus, before execution of the instrumentation code the original eflags register value as seen by the application is to be preserved prior to modifying the eflags register. However, accessing the eflags register is a fairly expensive operation because it must be done by pushing it onto the stack. Moreover, a switch to another stack may be performed before pushing/popping the eflags register to avoid changing the application stack.

The compiler may avoid saving/restoring the eflags register as much as possible by using a liveness analysis on the eflags register. The liveness analysis tracks the individual bits in the eflags register written and read by each instruction. If it is determined that the eflags register is dead at the point where an analysis routine call is inserted, saving and restoring of the eflags register may be avoided.

In some embodiments, the instrumentation code further may be optimized if it can be scheduled, provided that the resulting schedule still honors the original semantics of the instrumentation. For example, if a user wants to obtain an execution count of a basic block, he/she usually updates a counter at the basic block's entry. Nevertheless, it is legal to put the counter update anywhere inside the basic block. Having this scheduling feasibility opens up various optimization opportunities. For instance, the counter update may be placed at a point in the basic block where there is a free register or a dead register, for example. Then the counter update can take this register for its own use, thereby avoiding the need to spill a register. On an in-order machine such as the Intel® Itanium™ processor, the counter update may be scheduled into existing no operation (nops) instructions (if any) inside the basic block and hence the instrumentation could potentially be done at no cost.

In general, it is safe to schedule instrumentation code that does not access the register and memory values used in the application. This orthogonal relation between the instrumentation and the application may be referred to as “data independency”. In some embodiments, different approaches to scheduling instrumentation code may be effected. A first approach is a user-directed approach, where the tool writer provides hints to the instrumentation engine about where to schedule instrumentation code. The tool writer guarantees data independency. That is, the instrumentation tool may accept the user's indication of data independency at face value and schedule instrumentation code accordingly. The second approach is an automatic approach, in which the instrumentation engine itself analyzes the code to be instrumented and determines if the data independency exists.

In an implementation of the first approach, a user may be provided with a command to provide the data independency hint. The command may be termed “IPOINT_ANYWHERE”, in one embodiment. Via this command, the tool writer can specify that the instrumentation code can be scheduled anywhere within the scope of instrumentation (e.g., a basic block, trace, or function). Upon receiving this command, the instrumentation tool may seek to optimize the instrumentation code by selective scheduling of the code within the block or function. For instance, the compiler can insert the call (i.e., the instrumentation code or analysis routine) immediately before an instruction that overwrites a register (or eflags register) and thereby the analysis routine can use that register (or eflags register) without first spilling it.

As an example, an optimization that avoids saving/restoring the eflags register during execution of instrumented binary code may provide improved program performance. Different manners of avoiding overwriting of the eflags register in the instrumentation code may be performed.

A first method may analyze code of the instrumented scope (e.g., a basic block) for an instruction that overwrites the eflags register. If such an instruction, say i, is found, the instrumentation code may be scheduled immediately before i. Since the eflags register is already dead after i, there is no need to save the eflags register before executing the instrumentation code. Referring now to Table 1 below, shown is an example code segment that includes a number of instructions. The middle code block of Table 1 shows a basic block to be instrumented. As shown, the block includes an instruction to move the contents of a first register to a second register (i.e., esi to edi), and then to compare a value of the second register to another value. This comparison instruction will thus overwrite at least a portion of the eflags register. Finally, the code block includes a jump instruction to a target branch.

TABLE 1

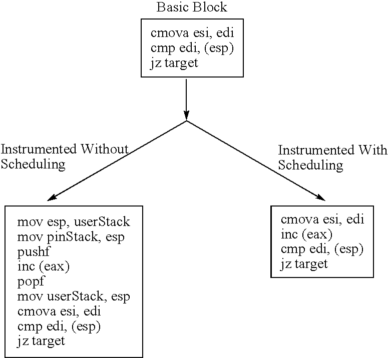

Table 1 also includes two instrumented versions of the code, namely an instrumented version in accordance with an embodiment of the present invention (shown on the right side of Table 1) and an instrumented version of the code segment without implementing optimization methods (i.e., instrumented without scheduling) as shown on the left side of Table 1.

Referring to the unoptimized instruction code on the left side of Table 1, since the eflags register is alive at the first instruction (cmova), the eflags register is saved and restored around the increment instruction (the desired instrumentation function). Also the instrumentation code switches to another stack before the pushf instruction, which flushes the entire processor pipeline, to avoid touching the user stack (for instrumentation transparency reasons). Accordingly, the instrumented code uses six instructions and further causes the entire processor pipeline to be flushed, which is a very expensive process.

In contrast, referring to the right side of Table 1, shown is an instrumented code block resulting from instrumentation in accordance with an embodiment of the present invention. Because the desired instrumentation instruction, namely a counter update (i.e., inc (eax)) is scheduled immediately before the compare instruction (cmp), which writes the eflags register, there is no need to save the eflags register. Accordingly, only a single instruction is added for purposes of the instrumentation. Furthermore, there is no need to spill any registers or change stacks. As such, the processor pipeline need not be flushed and execution of the instrumentation code is thus optimized.

If the first method is not applicable, a second method may be performed. Namely, an instruction in the scope being instrumented that overwrites a general-purpose register may be sought. With this free register, an instruction sequence may be generated that performs the intended instrumentation but does not modify the eflags register. An example is given in Table 2.

As shown in Table 2, an original code block is presented, along with an instrumented code version in accordance with an embodiment of the present invention (i.e., on the right side of Table 2), and an unoptimized instrumented version (i.e., on the left side of Table 2). As shown in Table 2, the original code block moves the contents of a first register to a second register (i.e., ebx to edi) and secondly moves the contents of a third register to a fourth register (i.e., esi to edx). Then the code block jumps to a target branch.

TABLE 2

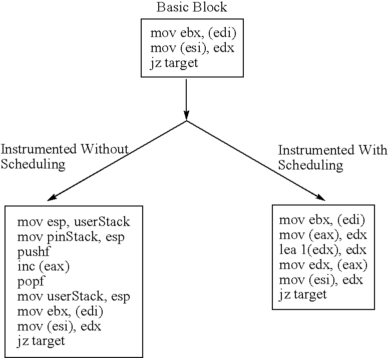

The optimized instrumented code block shown on the right side of Table 2 schedules three new instructions prior to the second move instruction. These three instructions make use of the free register edx to perform an increment without modifying the eflags register. The added instrumentation instruction “lea” is an x86 instruction that computes the effective address of the given addressing mode, and does not modify the eflags register. Accordingly, the optimized instrumented code adds three instructions and avoids saving/restoring of the eflags register. While shown with the use of this particular instruction and register in the embodiment of Table 2, it is to be understood that other instructions and registers that do not modify the eflags register or another conditional code register may be implemented in other embodiments.

In contrast, referring to the instrumented code block on the left side of Table 2, the original code block is instrumented in the same manner as described above regarding Table 1. Accordingly, expensive stack switches and processor flushes occur.

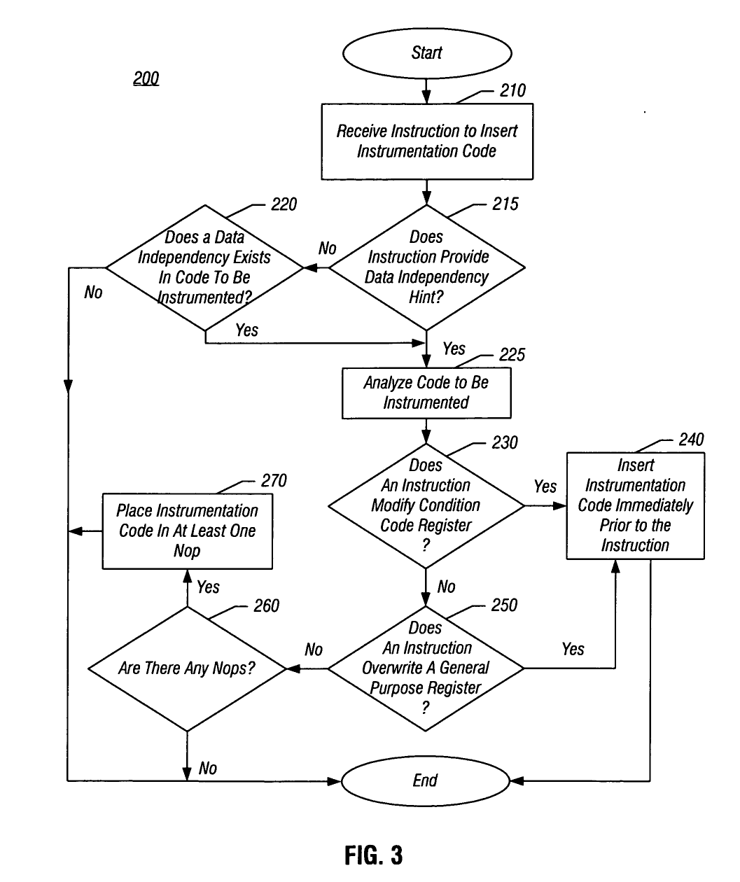

Referring now to FIG. 3, shown is a flow diagram of a method in accordance with an embodiment of the present invention. As shown in FIG. 3, method 200 may be used to optimize placement of instrumentation code within a code block. Method 200 may begin by receiving an instruction to insert the instrumentation code (block 210). As discussed above, such an instruction or command may be received from a tool writer. Next it may be determined if the instruction provides a data independency hint (diamond 215). As discussed above, this hint may indicate to the compiler or other instrumentation engine that there are no dependencies between application data and instrumentation data. If such a hint is present, control may pass directly to block 225 where the code to be instrumented is analyzed. For example, the code may be analyzed to determine whether one or more instructions within the code causes a condition code register (e.g., the eflags register) to be updated (e.g., modified or overwritten). If so, prior to that instruction the register is considered dead. Thus it may be determined whether an instruction modifies the condition code register (diamond 230). If so, the instrumentation code may be inserted immediately prior to that instruction (block 240). Accordingly, the instrumentation code has been scheduled to an optimized location and method 200 ends.

If instead at diamond 230 the analysis indicates that the condition code register is not modified, next it may be determined whether an instruction within the code overwrites a general-purpose register (diamond 250). In some embodiments, overwriting this general-purpose register may not affect the condition code register. If such an instruction exists, control may pass to block 240 where the instrumentation code is inserted immediately prior to such instruction (block 240). Thus an optimized location for the instrumentation code may be realized, and method 200 concludes.

If instead at diamond 250 it is determined that no instructions overwrite a general-purpose register, control may pass to diamond 260. There it may be determined whether any instructions in the code are no operation (nop) instructions (diamond 260). If one or more such instructions exist, instrumentation code may be placed in one or more of those nops (block 270). From both of block 270 and diamond 260, the method may conclude.

Even when a user does not provide a data independency hint, the instrumentation tool may attempt to schedule instrumentation code for purposes of optimization. Specifically, if at diamond 215 it is determined that the user does not provide a data independency hint, next it may be determined whether a data independency exists in the code to be instrumented (diamond 220). In various embodiments, the compiler may analyze the code to check for such independencies. If the independency exists, control may pass to block 225. In contrast, if no such independency exists, the method may terminate.

Embodiments may be implemented in a computer program. As such, these embodiments may be stored on a storage or signal medium including instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic RAMs (DRAMs), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

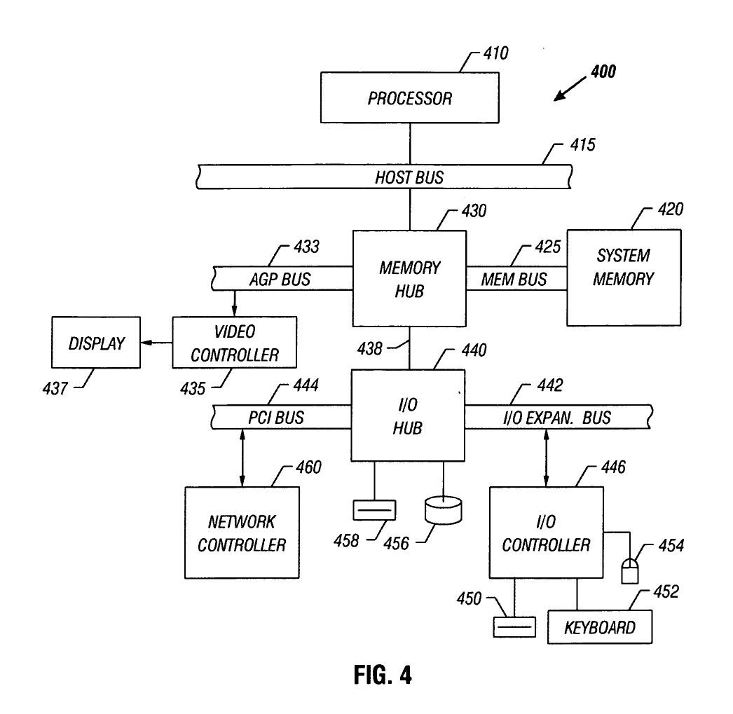

Now referring to FIG. 4, in one embodiment a computer system 400 includes a processor 410, which may include a general-purpose or special-purpose processor such as a microprocessor, microcontroller, a programmable gate array (PGA), and the like. As used herein, the term “computer system” may refer to any type of processor-based system, such as a desktop computer, a server computer, a laptop computer, or the like.

The processor 410 may be coupled over a host bus 415 to a memory hub 430 in one embodiment, which may be coupled to a system memory 420 (e.g., a dynamic random access memory (RAM)) via a memory bus 425. Programs such as an instrumentation tool and a JIT compiler in accordance with an embodiment of the present invention may be stored in system memory 420 during operation. The memory hub 430 may also be coupled over an Advanced Graphics Port (AGP) bus 433 to a video controller 435, which may be coupled to a display 437. The AGP bus 433 may conform to the Accelerated Graphics Port Interface Specification, Revision 2.0, published May 4, 1998, by Intel Corporation, Santa Clara, Calif.

The memory hub 430 may also be coupled (via a hub link 438) to an input/output (I/O) hub 440 that is coupled to a input/output (I/O) expansion bus 442 and a Peripheral Component Interconnect (PCI) bus 444, as defined by the PCI Local Bus Specification, Production Version, Revision 2.1 dated June 1995. The I/O expansion bus 442 may be coupled to an I/O controller 446 that controls access to one or more I/O devices. As shown in FIG. 4, these devices may include in one embodiment storage devices, such as a floppy disk drive 450 and input devices, such as keyboard 452 and mouse 454. The I/O hub 440 may also be coupled to, for example, a hard disk drive 456 and a compact disc (CD) drive 458, as shown in FIG. 4. It is to be understood that other storage media may also be included in the system.

The PCI bus 444 may also be coupled to various components including, for example, a network controller 460 that is coupled to a network port (not shown). Additional devices may be coupled to the I/O expansion bus 442 and the PCI bus 444, such as an input/output control circuit coupled to a parallel port, serial port, a non-volatile memory, and the like.

Although the description makes reference to specific components of the system 400, it is contemplated that numerous modifications and variations of the described and illustrated embodiments may be possible. More so, while FIG. 4 shows a block diagram of a system such as a personal computer, it is to be understood that embodiments of the present invention may be implemented in a wireless device such as a cellular phone, personal digital assistant (PDA) or the like.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
receiving a command to insert instrumentation code into a code segment;
analyzing the code segment to determine an optimal location for the instrumentation code within the code segment; and
inserting the instrumentation code at the optimal location to generate an instrumented code segment.

2. The method of claim 1, wherein receiving the command comprises receiving an indication from a user of a data independency between the code segment and the instrumentation code.

3. The method of claim 1, wherein analyzing the code segment comprises determining if an instruction of the code segment causes an update to a condition code register.

4. The method of claim 3, further comprising inserting the instrumentation code immediately prior to the instruction.

5. The method of claim 1, wherein analyzing the code segment comprises determining if an instruction of the code segment overwrites a general-purpose register.

6. The method of claim 1, further comprising automatically analyzing the code segment without receiving a data independency hint from a user.

7. The method of claim 1, wherein inserting the instrumentation code at the optimal location prevents movement of register data to a stack.

8. The method of claim 1, further comprising analyzing the code segment using a just-in-time compiler.

9. The method of claim 1, wherein inserting the instrumentation code comprises dynamically instrumenting the code segment.

10. The method of claim 1, further comprising storing the instrumented code segment in a code cache and executing the instrumented code segment from the code cache.

11. The method of claim 1, wherein the optimal location comprises a no operation instruction of the code segment.

12. A method comprising:
receiving a data independency hint from a user corresponding to a relation between application data of an application program and instrumentation data of instrumentation code;
scheduling a position within the application program for the instrumentation code based on the data independency hint; and
inserting the instrumentation code at the scheduled position.

13. The method of claim 12, further comprising analyzing the application program to determine if an instruction causes an update to a condition code register.

14. The method of claim 13, wherein scheduling the position comprises selecting a location immediately prior to the instruction for inserting the instrumentation code.

15. The method of claim 12, further comprising analyzing the application program to determine if an instruction overwrites a general-purpose register.

16. An article comprising a machine-accessible medium having instructions that when executed cause a system to:
receive a command to insert instrumentation code into a code segment;
analyze the code segment to determine an optimal location for the instrumentation code within the code segment; and
insert the instrumentation code at the optimal location to generate an instrumented code segment.

17. The article of claim 16, further comprising instructions that when executed cause the system to receive an indication from a user of a data independency between the code segment and the instrumentation code.

18. The article of claim 16, further comprising instructions that when executed cause the system to determine if an instruction of the code segment causes an update to a condition code register.

19. The article of claim 16, further comprising instructions that when executed cause the system to dynamically instrument the code segment.

20. The article of claim 16, further comprising instructions that when executed cause the system to store the instrumented code segment in a code cache and execute the instrumented code segment from the code cache.

21. A system comprising:
a storage including instructions that when executed cause the system to receive a data independency hint from a user corresponding to a relation between application data of an application program and instrumentation data of instrumentation code, schedule a position within the application program for the instrumentation code based on the data independency hint, and insert the instrumentation code at the scheduled position; and
a dynamic random access memory coupled to the storage.

22. The system of claim 21, further comprising a just-in-time compiler to compile the application program and to insert the instrumentation code therein.

23. The system of claim 22, further comprising a code cache to store the compiled application program including the instrumentation code.

24. The system of claim 21, wherein the storage further includes instructions that when executed cause the system to analyze the application program to determine if an instruction causes an update to a condition code register.

25. The system of claim 23, further comprising a dispatcher to launch the compiled application program.

26. The system of claim 22, further comprising a virtual machine including the just-in-time compiler, an emulation unit and a dispatcher.
